(19) United States
(12) Patent Application Publication
(10) Pub. No.: US 2025/0284511 A1
(43) Pub. Date: Sep. 11, 2025

(54) SYSTEM AND METHOD FOR INTEROPERABLE DIGITAL ASSET CREATION, MANAGEMENT AND EXECUTION

(71) Applicant: Futureverse IP Limited, Auckland (NZ)

(72) Inventors: Marco Brondani, Auckland (NZ); David Delgado, Auckland (NZ)

(21) Appl. No.: 19/071,518

(22) Filed: Mar. 5, 2025

Related U.S. Application Data
(60) Provisional application No. 63/561,557, filed on Mar. 5, 2024.
(60) Provisional application No. 63/677,691, filed on Jul. 31, 2024.

(51) Int. Cl. G06F 9/455; G06F 8/34; G06F 8/71

(52) U.S. Cl. CPC G06F 9/45508; G06F 8/34; G06F 8/71

(57) ABSTRACT

A system for creating and executing interoperable digital assets includes a blueprint editor for creating engine-agnostic blueprints defining asset composition and behavior, an asset registry for storing and managing the blueprints, and an interpreter for executing the blueprints within a target application. The interpreter is configured to translate the engine-agnostic blueprints into engine-specific instructions for the target application. The blueprint editor comprises a visual scripting interface for creating the engine-agnostic blueprints using pre-defined functional nodes. The asset registry includes a database for storing and versioning the blueprints. The interpreter is configured to dynamically load and execute the blueprints at runtime within the target application and comprises a plugin or SDK specific to the target application's game engine.

### RELATED APPLICATION DATA

This application claims priority to U.S. Provisional App. Ser. No. 63/677,691 filed on Jul. 31, 2024, and U.S. Provisional App. Ser. No. 63/561,557 filed on Mar. 5, 2024, the disclosures of which are incorporated herein by reference.

### FIELD OF INVENTION

The present disclosure relates to systems and methods for creating, managing and executing digital assets, and more particularly to a framework for developing engine-agnostic, interoperable digital assets using visual scripting and runtime interpretation.

### BACKGROUND

Digital assets (also referred to merely as “assets” herein) have become increasingly important in various computing platforms and execution environments, including video games, virtual reality, and interactive media. These assets encompass a wide range of elements, such as 3D models, textures, animations, and behaviors that define how objects and characters interact within digital environments. As the complexity and diversity of digital platforms have grown, developers face challenges in creating assets that can be seamlessly used across different engines and applications.

Conventional digital assets are tightly coupled to specific game engines or development environments. This coupling often results in limited portability and reusability of assets across different platforms or projects. Developers frequently need to recreate or significantly modify assets when transitioning between engines or updating to new versions, leading to increased development time and costs.

The process of creating and managing digital assets typically involves multiple specialized tools and workflows. Artists can use 3D modeling software to create visual elements, while programmers define behaviors and interactions through code. This separation of concerns can lead to inefficiencies and communication challenges between different team members involved in asset creation. Each rendering engine has corresponding pipelines for creating, storing, and rendering assets. Furthermore, as digital experiences become more dynamic and personalized, there is an increasing need for systems that allow for real-time modification and updating of assets. Static asset pipelines can struggle to meet the demands of live services and frequently updated content, where rapid iteration and deployment are often required.

As just one example, rendering assets consistently between Unreal Engine (UE) and Unity™ is difficult due to differences in their rendering pipelines, shading models, and material systems. Key reasons for this are set forth below:
Unreal Engine primarily uses Physically Based Rendering (PBR) with its Deferred Renderer (though it also supports Forward Rendering).
Unity supports Built-in Render Pipeline (BRP), Universal Render Pipeline (URP), and High Definition Render Pipeline (HDRP), each with different material behaviors.
Unreal uses its own PBR shading model (based on Disney's principles) with features like Subsurface Scattering (SSS) and Clearcoat, which Unity may not support natively.
Unity's HDRP has a similar PBR model but behaves differently in how it calculates reflections, light attenuation, and roughness.
Unreal typically uses Metallic-Roughness workflow, while Unity (especially HDRP) can use Metallic-Roughness or Specular-Glossiness, requiring different textures or conversion. Normal map formats may differ (e.g., DirectX vs. OpenGL tangent space). Texture samplers and tiling options vary across engines.
Unreal applies Tonemapping, Ambient Occlusion, and Bloom differently from Unity, affecting how materials appear under different lighting conditions. Unity's HDRP provides control over these, but replicating Unreal's look exactly requires fine-tuning.
Unreal uses its Material Editor (node-based system), whereas Unity uses Shader Graph (for URP/HDRP) or manually written shaders.
Shader features like translucency, anisotropy, and clearcoat reflections may not directly translate between engines.

For at least these reasons, achieving similar material rendering between Unreal and Unity requires manual adjustments, custom shader work, and possibly texture conversions due to fundamental differences in rendering technology and pipelines. In summary, interoperability between different platforms and engines remains a significant challenge in the digital asset ecosystem. Each platform has a unique proprietary format, rendering techniques, and performance considerations, making it difficult to create truly universal assets that maintain consistent appearance and behavior across diverse environments.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

As the demand for high-quality digital content continues to grow, developers and content creators seek more efficient and flexible ways to create, manage, and deploy digital assets. This disclosure describes systems, methods, and media ‘collectively referred to as a “Universal Blueprint Framework” (UBF), which streamline digital asset development processes, reduce redundancy, and enable more seamless experiences across a variety of digital platforms.

According to an aspect of the present disclosure, a system for creating and executing interoperable digital assets is provided. The system includes an editor for creating engine-agnostic “blueprints” defining the composition and behavior of digital assets as well as relationships between assets. The system includes an asset registry for storing and managing the blueprints. The system includes an interpreter for allowing execution of the blueprints within a target execution environment, wherein the interpreter is configured to translate data of the engine-agnostic blueprints into engine-specific instructions for the target execution environment.

According to other aspects of the present disclosure, the system can include one or more of the following features. The blueprint editor can comprise a visual, graphical scripting interface for creating the engine-agnostic blueprints using pre-defined functional nodes. The pre-defined functional nodes can include nodes for spawning 3D models, applying materials, and defining asset behaviors, characteristics and relationships. An asset registry can comprise a database for storing and versioning the blueprints. The asset registry can further comprise an API for querying and retrieving blueprints. The interpreter can be configured to dynamically load and execute the blueprints at runtime within the target application, platform, and/or engine. The target application, platform, and/or engine is referred to as and “execution environment” herein. The interpreter can comprise a plugin or SDK specific to the target application's game engine.

According to another aspect of the present disclosure, a non-transitory computer-readable medium storing instructions that, when executed by a processor, cause the processor to perform operations for creating and executing interoperable digital assets is provided. The operations include receiving an engine-agnostic blueprint defining asset composition and behavior. The operations include storing the blueprint in an asset registry. The operations include executing the blueprint within a target execution environment using an interpreter, wherein the interpreter translates the engine-agnostic blueprint into engine-specific instructions for the target execution environment.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the attached drawing in which:

FIG. 1 is high level diagram of a data model according to aspects of the present disclosure;

FIG. 2 depicts a system diagram of a UBF architecture according to aspects of the present disclosure;

FIG. 3 is a flowchart for creating and executing interoperable digital assets according to aspects of the present disclosure;

FIG. 4 is a flowchart for runtime execution of a UBF Blueprint according to aspects of the present disclosure;

FIG. 5 is a block diagram of a computer system which can be used to implement aspects of the present disclosure; and

FIG. 6 illustrates a node-based visual scripting interface for creating engine-agnostic blueprints according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

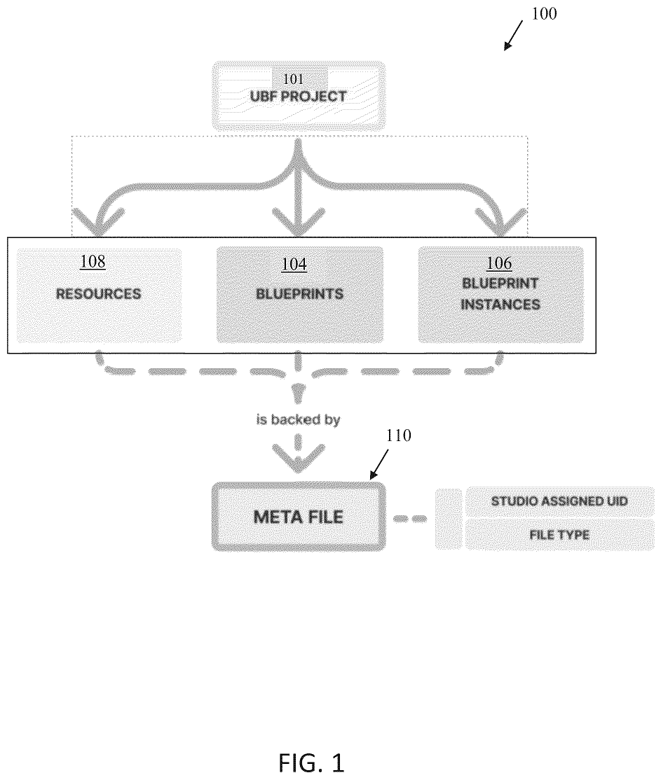

The Universal Blueprint Framework (UBF) provides a comprehensive system for creating and executing interoperable digital assets across various platforms and applications. FIG. 1 illustrates a data model of the Universal Blueprint Framework (UBF). The data model can comprise an asset registry 100. Note that in this instance, the phrase “asset registry” is used to refer to a data structure. However, asset registry can also be the device in which the data structure is stored. An editor (discussed in greater detail below) can be used for creating projects 101 to be stored in the asset registry. Each project can be data structure defining asset composition, behavior, and relationships in a manner that is independent of any specific game engine or platform. The editor can allow content creators to design and structure digital assets using a visual interface or scripting language (described below) that abstracts away engine-specific details.

As shown in FIG. 1, the projects 101 can include blueprints 104, blueprint instances 106, and resources 108. The asset 102 registry can provide a centralized (or distributed) repository for organizing, versioning, and accessing blueprints created using the editor. In some cases, the asset registry can facilitate efficient retrieval and management of blueprints across multiple projects or applications. Blueprints, resources, and blueprint instances will be described in greater detail below. Metafile 110 can include files, values, and/or links to content, that are leveraged by blueprints in the manner described below.

An interpreter executes blueprint instances within a target execution environment. The interpreter can be responsible for translating the engine-agnostic blueprints into engine-specific instructions that can be understood and executed by the target application's runtime environment. This translation process can enable the same blueprint to be used across different execution environments without requiring manual conversion or reimplementation. The interpreter is also described in greater detail below.

The system comprising the editor, asset registry, and interpreter can work together to enable the creation, storage, and execution of interoperable digital assets. In some cases, content creators can use the editor to design assets, which are then stored in the asset registry. When a target application requests an asset, the interpreter can retrieve the corresponding blueprint instance from the asset registry and translate it into instructions that can be executed within the specific environment of the target application.

By utilizing engine-agnostic blueprints and a flexible interpreter system, the UBF can allow for greater interoperability of digital assets across different platforms and applications. This approach can reduce the need for platform-specific asset creation and can streamline the process of deploying content across multiple environments.

The UBF can support runtime execution of digital assets. The interpreter can dynamically load and translate blueprints at runtime, allowing for real-time updates and modifications to assets without requiring application restarts or extensive recompilation. This feature can enable more flexible and dynamic content delivery in interactive applications such as video games or virtual environments.

The UBF can provide a structured approach to managing digital assets throughout their lifecycle, from creation to execution. By separating the asset definition (blueprint) from its implementation (interpreter), the UBF can offer a more modular and maintainable system for handling complex digital content across diverse platforms and applications.

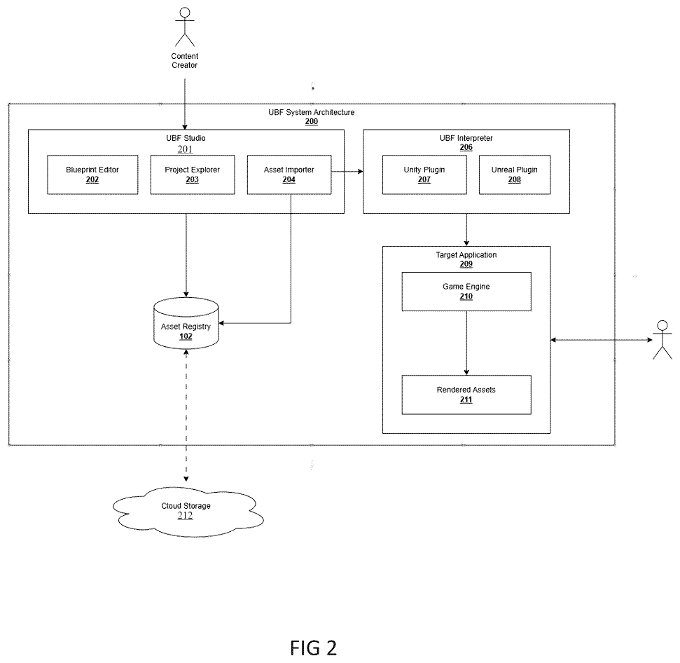

A system architecture 200 in accordance with disclosed implementations is illustrated in FIG. 2. As shown in FIG. 2. The UBF in this example comprises several interconnected components that work together to enable the creation, management, and execution of interoperable digital assets across various platforms and applications.

A blueprint creation component 201 can be accessed by a content creator using a computing device and serves as an interface for content creation and project management within the UBF ecosystem. The creation component 201 can include sub-components such as editor component 202, project explorer component 203, and asset importer component 204. These tools can allow content creators to develop, organize, and manage UBF projects efficiently and are described in more detail below. Asset registry 102 can include a hardware component which functions as a repository for storing and managing the data structures shown in FIG. 1. In some cases, the Asset Registry can communicate bidirectionally with cloud storage 212, enabling data persistence and sharing across the system and other systems.

The interpreter component 206 can be responsible for processing blueprints and assets, and for facilitating integration thereof into target applications by translating blueprint instances into runtime instructions. The interpreter component 206 can include plugins or SDKs specific to different game engines. For example, the interpreter component 206 can comprise a Unity™ Plugin 207 and an Unreal™ Plugin 208, allowing compatibility with these popular game engines. The use of interpreter plugins or SDKs specific to the target application's game engine can enable efficient translation of engine-agnostic blueprints into engine-specific runtime instructions. This approach can allow the same blueprint to be executed across different game engines or platforms without requiring manual conversion or reimplementation.

In some cases, the UBF system architecture can include a target application component 209 which represents the target execution environment where the digital asset is utilized. The target application component can contain a game 210 engine and rendered assets 211, which can be the final output of the asset visible to end-users.

The system can operate by allowing content creators to develop and/or assemble blueprints, resources, and blueprint instances in the editor component. The blueprints resources, and blueprint instances can then be stored in the asset registry 102. When a target application requests an asset, the interpreter component 206 can retrieve the corresponding blueprint instance from the asset registry 102 and process it at runtime using the appropriate plugin or SDK for the target execution environment.

In some cases, the blueprint creation component 201 can include an explore/previewer tool 203 which allows visual inspection of UBF artifacts in real-time. This tool can enable content creators and developers to preview and validate their assets before integration into the target application, potentially streamlining the development process and reducing errors. Asset importer tool allows the user to import an existing asset from the asset registry 102 to use in a project.

The UBF system architecture can facilitate communication and data flow between its various components. For example, the Editor 202 can send data to the asset registry 102, which in turn can have a bidirectional connection with cloud storage 212. The interpreter 206 can communicate bidirectionally with the asset registry 102 and send processed data to the target execution environment 209.

By utilizing this modular architecture with specialized components for creation, storage, interpretation, and execution, the UBF system can enable greater interoperability of digital assets across different platforms and applications. This approach can reduce the need for platform-specific asset creation and can streamline the process of deploying content across multiple environments.

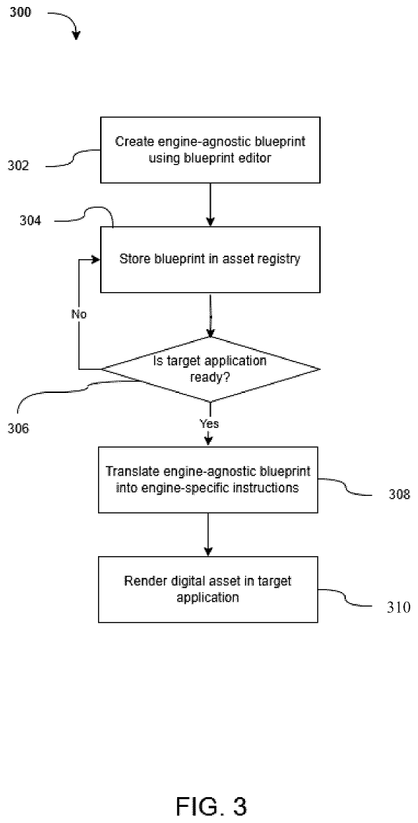

FIG. 3 illustrates a flowchart depicting a method 300 of creating and executing interoperable digital assets using the UBF system. The method 300 can begin with creating an engine-agnostic blueprint defining asset composition and behavior using a blueprint editor at 302. The blueprint editor can provide a visual scripting interface with pre-defined functional nodes for creating the engine-agnostic blueprint. This approach can allow content creators to design and structure digital assets using a visual interface that abstracts away engine-specific details. Creation of a blueprint is discussed in more detail below.

At 304, the process can store the blueprint in an asset registry. The process can proceed to a decision point, at 306, where the system determines if the target application is ready. This step can ensure that the target application is prepared to receive and execute the blueprint. Once the target application is ready, the process can move to 308 in which the blueprint is translated into engine-specific instructions for the target application. The blueprint can then be executed and rendered in the target execution platform at 310. This process can enable the same blueprint to be used across different game engines or platforms without requiring manual conversion or reimplementation.

In some cases, executing the blueprint can comprise dynamically loading and executing the blueprint at runtime within the target application. This dynamic execution can allow for real-time updates and modifications to assets without requiring application restarts or extensive recompilation.

By utilizing this structured approach to creating and executing interoperable digital assets, the UBF system can enable greater flexibility and efficiency in deploying content across multiple platforms and applications. The use of engine-agnostic blueprints and a flexible interpreter system can reduce the need for platform-specific asset creation and streamline the process of integrating digital assets into diverse target applications.

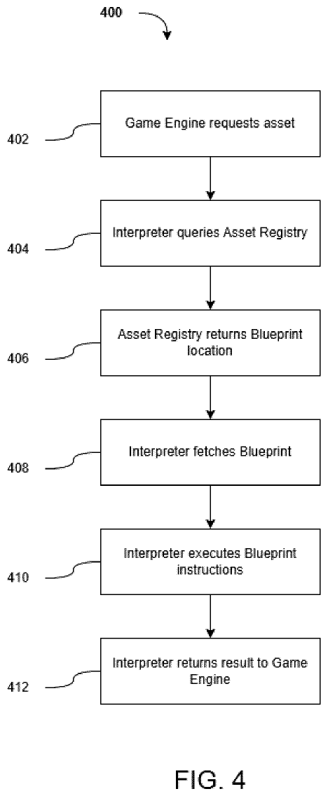

FIG. 4 illustrates a flowchart depicting, in more detail, the method of runtime execution 400 (Steps 306, 308 and 310 of FIG. 3) of UBF Blueprints.

The process can begin at 402 with a game engine, or other execution environment component, requesting an asset during runtime. This request can initiate the blueprint execution process, triggering the subsequent steps in the flowchart. Following the asset request, the interpreter can query the asset registry at 404. This step can involve the interpreter communicating with the asset registry in a known manner to locate the appropriate blueprint instance for the requested asset. The query can, for example, specify a unique ID of the requested blueprint instance that is used to retrieve the blueprint instance.

At 406, the asset registry can then return the blueprint instance location, such as a network address, to the interpreter. This information can enable the interpreter to locate and retrieve the necessary blueprint data for execution. At 408, the location can be used to fetch the blueprint data. This step can involve retrieving the blueprint data from the specified location, which can be a local storage system or a remote server.

After fetching the blueprint data, the interpreter can execute the blueprint instructions at 410. In some cases, the interpreter can be configured to dynamically load and execute blueprint data at runtime. This dynamic execution can allow for real-time updates and modifications to assets without requiring application restarts or extensive recompilation. During the execution process, the interpreter can handle error or exception cases that can arise when executing blueprints. This error handling capability can enhance the robustness of the system, allowing for graceful recovery from unexpected situations or invalid blueprint instructions.

In some cases, the system can allow for overriding materials or skeletons when executing blueprints. This feature can provide flexibility in asset rendering, allowing developers to customize the appearance or structure of assets based on specific requirements or preferences of the target execution environment. The final step in the process can involve the interpreter returning the result to the game engine at 412. This result can include the fully rendered asset or any other output specified by the executed blueprint instance.

By utilizing this runtime execution process, the UBF system can enable efficient and flexible deployment of digital assets across various platforms and applications. The dynamic loading and execution of blueprints, combined with error handling capabilities and customization options, can provide a robust framework for managing and rendering interoperable digital assets in real-time environments.

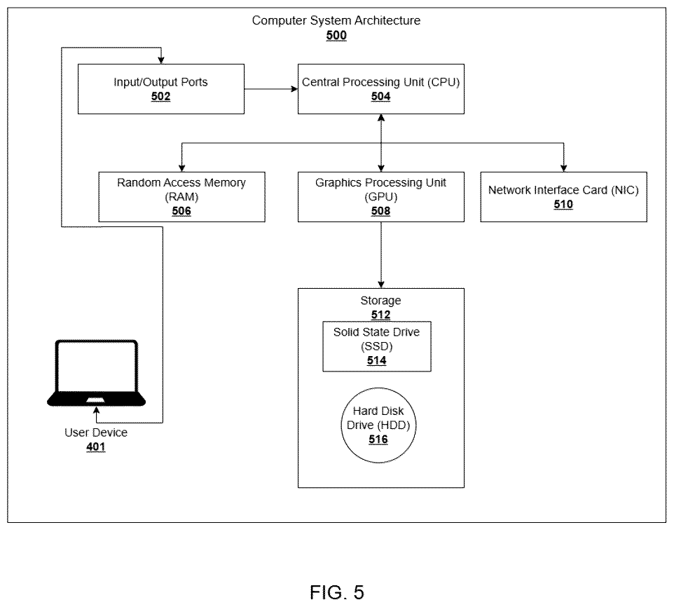

The UBF can be implemented using a computer system architecture as illustrated in FIG. 5. This architecture can provide the necessary hardware components to support UBF operations, including the creation, storage, and execution of interoperable digital assets. While the computer system is described as having on processor, one storage etc. . . . , each element described below can one or more elements in a distributed computing system The computer system architecture 500 can include a user device 501 which can serve as the interface for content creators and developers to interact with other components of the UBF system through Input/Output ports 502. The user device 501 can be a personal computer, workstation, or other computing device capable of running UBF Editor and related applications. For example, the user device 501 can execute a web browser to access the other components of the system over the Internet.

A central processing unit (CPU) 502. The CPU 502 can be responsible for executing the instructions that drive UBF operations, including blueprint creation, asset management, and interpretation processes. Random access memory (RAM) 506 can provide temporary data storage for UBF operations, allowing for quick access to frequently used data and instructions. In some cases, the RAM 506 can store active blueprints, asset data, and interpreter instructions during runtime execution. A storage component 512 can include a solid-state drive (SSD) 514 and a hard disk drive (HDD) 516. These storage devices can provide persistent data storage capabilities for the UBF system. In some cases, the SSD can store frequently accessed UBF data, such as commonly used blueprints and assets, while the HDD can store larger collections of assets and project files.

A GPU 508 can handle graphics-related computations and display output. In some cases, the GPU 508 can be utilized for rendering complex 3D assets defined by UBF blueprints, particularly in real-time preview scenarios or when executing blueprints within target applications. A network interface card (NIC) 510 can enable network connectivity for the UBF system. In some cases, the NIC 510 can facilitate communication between UBF components, such as allowing the UBF Interpreter to query remote Asset Registries or enabling collaborative work on UBF projects.

In some cases, the computer system architecture can include non-transitory computer-readable media storing instructions for creating and executing interoperable digital assets. These instructions, when executed by the CPU 504, can cause the computer system to perform various UBF operations. The non-transitory computer-readable media can be implemented using the storage component 512.

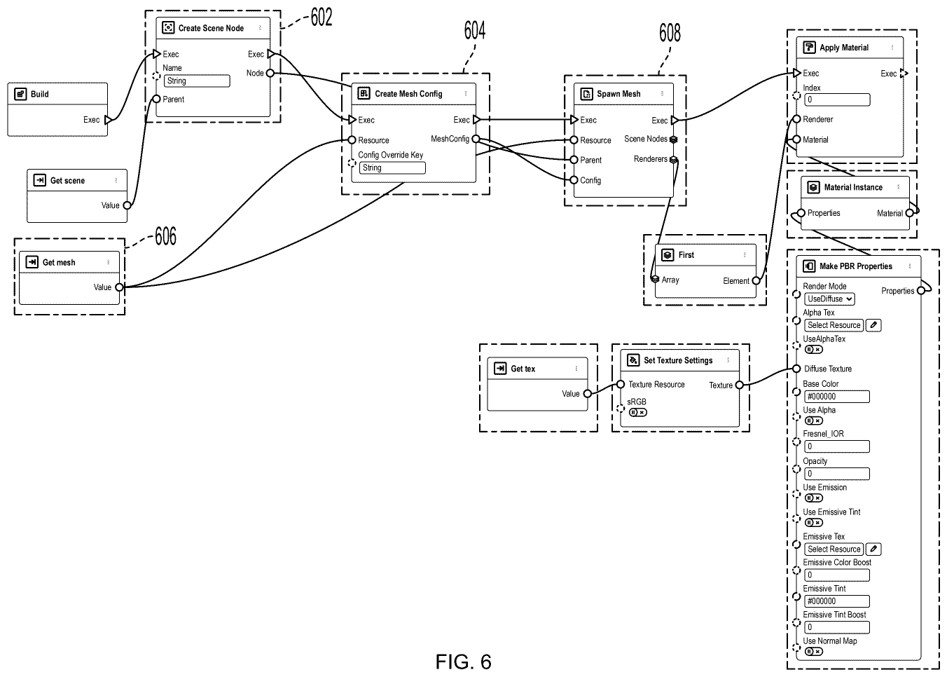

FIG. 6 illustrates an example of a node-based visual scripting user interface that can be used within the editor component to create blueprints. The user interface can include a viewport for visually arranging and connecting nodes, thus presenting a workspace where users can create and manipulate the structure of their blueprints using a graphical interface. The node-based visual scripting interface can include various pre-defined functional nodes. These nodes can represent different operations or components that can be combined to define asset composition and behavior. In some cases, the pre-defined functional nodes can include nodes for spawning 3D models, applying materials, and defining asset behaviors.

FIG. 6 shows a create scene node 602 connected to multiple other nodes through execution and data flow connections. The connections between nodes in the visual scripting interface can be represented by curved lines, indicating the flow of execution and data between different functional components. In some cases, the system can support both execution flows and data flows, with execution flows potentially shown by thicker lines and data flows by thinner connecting lines between nodes. For example, create scene node 602 has an output execution port coupled to an input execution port of create mesh config node 604. A resource input of create mesh config node 604 is connected to a value output of a get mesh node 606 that specifies the mesh, such as through a pointer to a file. For example, the mesh could be a game character image. The get mesh node 606 has a value output that is connected to a resource input of a spawn mesh node 608. In a similar manner, the texture of and other characteristics of the mesh are specified by connections to other nodes.

The editor component can include a component for configuring blueprint properties and variables to allow users to define and manage various aspects of the blueprint, such as inputs, variables, and outputs. These properties can be used to control the behavior of the blueprint and enable customization of the asset.

Blueprint instances are instances of a blueprint which specify parameter values for the blueprint. Blueprint Instances can allow users to create variations of a blueprint by providing different input values or configurations, without modifying the underlying blueprint structure.

By utilizing a visual scripting interface with pre-defined functional nodes, the UBF system can enable users to create complex, engine-agnostic blueprints without requiring extensive programming knowledge. This approach can allow for more intuitive and efficient creation of interoperable digital assets across various platforms and applications.

Various types of nodes can be preconfigured in the editor for use in building blueprints. A build node defines and entry point for execution of the blueprint by the interpreter (discussed below). A spawn mesh node allows selection or import of a 3D mesh (e.g., a bear body). An apply material node binds a material or texture to the mesh that will be used as the surface of the mesh. Textures or colors can be customized by creating a parameter input to pass data to the interpreter at runtime. A SetBlendShape node adjusts a morph target or facial rig. A Branch/ForEach/Math Node provides basic logic for advanced use cases (conditional appearances, randomization, etc.). An AttachAccessory node is used to attach sub-blueprints (e.g., attach a hat to the main character).

While the terms “blueprint” and “blueprint instance” have been used somewhat interchangeable above, a blueprint is a definition of an asset for a category of items, for example hats, while a blueprint instance reuses the structure of a blueprint with specific different parameters (e.g., a red cowboy hat).

An example of portions of a data structure of a blueprint instance corresponding to the node diagram of FIG. 6 is set forth below. The entirety of the data structure is set forth in the attached Code Appendix. Note that the data structure in this example is entirely specification data and does not include any executable code. It can be seen that the create scene node 602 of FIG. 6 is defined by data, without any executable code. The node is given unique ID and all inputs, outputs, resources, values and references are specified in the data structure.

```
...
  {
    “id”:“q3jioX3PA7Sxou1RVhmUc”,
    “x”:380,
    “y”:−170,
    “type”:“CreateSceneNode”,
    “inputs”:[
      {
        “id”:“Exec”,
        “name”:“Exec”,
        “type”:“exec”,
        “hidden”:false,
        “supported”:[ ]
      },
      {
        “id”:“Name”,
        “type”:“string”,
        “name”:“Name”,
        “supported”:[ ],
        “hidden”:false
      },
      {
        “id”:“Parent”,
        “type”:“SceneNode”,
        “name”:“Parent”,
        “supported”:[ ],
        “hidden”:false
      }
    ],
    “outputs”:[
      {
        “id”:“Exec”,
        “name”:“Exec”,
        “type”:“exec”,
        “hidden”:false,
        “supported”:[ ]
      },
      {
        “id”:“Node”,
        “type”:“SceneNode”,
        “name”:“Node”,
        “supported”:[ ],
        “hidden”:false
      }
    ]
  },
```

The asset registry can be a database system including and Application Programming Interface (API) for querying and retrieving blueprints. This database can utilize a relational database management system (RDBMS) such as PostgreSQL or a NoSQL database like MongoDB, depending on the specific requirements of the UBF implementation. The asset registry API can support various query parameters to facilitate efficient blueprint retrieval. These parameters can include:
Blueprint ID: A unique identifier for each blueprint, typically a UUID (Universally Unique Identifier)
Version number: An integer representing the specific version of a blueprint
Tags: Metadata labels associated with blueprints for categorization
Creation date: The timestamp when the blueprint was initially created
Last modified date: The timestamp of the most recent update to the blueprint

The asset registry API can utilize RESTful principles and return responses in JSON format. A sample API endpoint for retrieving a specific blueprint version can be structured as follows:

```
‘‘‘
GET /api/v1/blueprints/{blueprint_id}/versions/{version_number}
‘‘‘
The response can include the following JSON structure:
‘‘‘json
{
  ″blueprint_id″: ″550e8400-e29b-41d4-a716-446655440000″,
  ″version_number″: 2,
  ″name″: ″Character_Base″,
  ″description″: ″Base blueprint for humanoid characters″,
  ″tags″: [″character″, ″humanoid″, ″base″],
  ″created_at″: ″2023-05-15T10:30:00Z″,
  ″updated_at″: ″2023-05-20T14:45:00Z″,
  ″data″: {
  // Blueprint-specific data structure
  }
}
‘‘‘
```

Storing blueprints in the asset registry can involve versioning to maintain a history of changes and allow for rollbacks if necessary. The asset registry can maintain metadata about the published blueprints, including, for example, corresponding S3 URLs to facilitate efficient retrieval and caching strategies. In some cases, the asset registry API can provide endpoints for retrieving the S3 URLs of published blueprints, allowing client applications to download the blueprint files directly from a hosting environment. To optimize performance, the asset registry can implement caching mechanisms at various levels. This can include in-memory caches for frequently accessed blueprints, as well as Content Delivery Network (CDN) integration for globally distributed access to published blueprint files.

The asset registry can support bulk operations for efficient management of multiple blueprints. These operations can include:
Batch retrieval of multiple blueprints
Bulk tagging or updating metadata for multiple blueprints
Exporting and publishing multiple blueprints in a single operation

The asset registry can provide monitoring and analytics capabilities to track usage patterns, popular blueprints, and system performance. This can involve integration with logging and metrics systems such as Elasticsearch, Logstash, and Kibana (ELK stack) or cloud-native solutions like Amazon CloudWatch.

In some cases, the interpreters in the Universal Blueprint Framework (UBF) may utilize a multi-stage translation process to convert engine-agnostic blueprints into native engine commands. This process may involve parsing the blueprint's structure, generating an intermediate representation, and then producing engine-specific code or instructions.

The interpreter, such as interpreter 206 of FIG. 2, can include one or more engine-specific plugins or SDKs that read a blueprint's generic, engine-agnostic data and convert them into the native commands required by that particular engine. While each interpreter may carry out different tasks under the hood, the overarching goal is the same: to translate a generic blueprint into a functionally equivalent result within its own domain.

Because no two engines handle rendering in the exact same way, interpreters ensure that the end results are as close as possible in each environment, without guaranteeing pixel-perfect parity. In other words, a character might look slightly different due to unique rendering pipelines between Unity and Unreal, but it will remain consistent in its core design and behavior. The interpreter may implement a custom domain-specific language (DSL) parser to read and understand the blueprint's syntax and semantics. This parser may utilize techniques such as abstract syntax trees (ASTs) or parsing expression grammars (PEGs) to efficiently process the blueprint's structure and extract relevant information.

The interpreter may employ a symbol table to manage and resolve references to variables, functions, and assets within the blueprint. This symbol table may be dynamically updated during the translation process to handle scoping rules and ensure proper resolution of identifiers across different sections of the blueprint.

The translation process may involve mapping generic blueprint nodes to engine-specific constructs. For example, a “Spawn Mesh” node in the blueprint may be translated to Unity's Instantiate( ) method or Unreal Engine's SpawnActor( ) function, depending on the target engine. This mapping may be implemented using a combination of lookup tables and custom translation functions for more complex operations.

A number of implementations have been described. Nevertheless, it will be understood that various modifications can be made without departing from the spirit and scope of the disclosure. Accordingly, other implementations are within the scope of the following claims.

What is claimed:

1. A system for creating and executing interoperable digital assets, comprising:
a blueprint editor for creating engine-agnostic blueprints including a data structure defining asset composition and behavior;
an asset registry for storing and managing the blueprints; and
an interpreter for executing the blueprints within a target application, wherein the interpreter is configured to translate the data structure into engine-specific instructions for the target application at runtime.

2. The system of claim 1, wherein the blueprint editor comprises a visual scripting interface for creating the engine-agnostic blueprints using pre-defined functional nodes.

3. The system of claim 2, wherein the pre-defined functional nodes include nodes for spawning 3D models, applying materials, and defining asset behaviors.

4. The system of claim 1, wherein the asset registry comprises a database for storing and versioning the blueprints.

5. The system of claim 4, wherein the asset registry further comprises an API for querying and retrieving blueprints.

6. The system of claim 1, wherein the interpreter is configured to dynamically load and execute the blueprints at runtime within the target application.

7. The system of claim 6, wherein the interpreter comprises a plugin or SDK specific to the target application's game engine.

8. A method for creating and executing interoperable digital assets, comprising:
creating an engine-agnostic blueprint including a data structure defining asset composition and behavior using a blueprint editor;
storing the blueprint in an asset registry; and
executing the blueprint within a target application using an interpreter, wherein the interpreter translates the data structure into engine-specific instructions for the target application at runtime.

9. The method of claim 8, wherein creating the engine-agnostic blueprint comprises using a visual scripting interface with pre-defined functional nodes.

10. The method of claim 9, wherein the pre-defined functional nodes include nodes for spawning 3D models, applying materials, and defining asset behaviors.

11. The method of claim 8, wherein storing the blueprint in the asset registry comprises versioning the blueprint.

12. The method of claim 11, further comprising providing an API for querying and retrieving blueprints from the asset registry.

13. The method of claim 8, wherein executing the blueprint comprises dynamically loading and executing the blueprint at runtime within the target application.

14. The method of claim 13, wherein the interpreter comprises a plugin or SDK specific to the target application's game engine.

15. A non-transitory computer-readable medium storing instructions that, when executed by a processor, cause the processor to perform operations for creating and executing interoperable digital assets, the operations comprising:
receiving an engine-agnostic blueprint including a data structure defining asset composition and behavior;
storing the blueprint in an asset registry; and
executing the data structure within a target application using an interpreter, wherein the interpreter translates the engine-agnostic blueprint into engine-specific instructions for the target application at runtime.

16. The non-transitory computer-readable medium of claim 15, wherein receiving the engine-agnostic blueprint comprises receiving a visual script created using pre-defined functional nodes.

17. The non-transitory computer-readable medium of claim 16, wherein the pre-defined functional nodes include nodes for spawning 3D models, applying materials, and defining asset behaviors.

18. The non-transitory computer-readable medium of claim 15, wherein storing the blueprint in the asset registry comprises versioning the blueprint.

19. The non-transitory computer-readable medium of claim 18, wherein the operations further comprise providing an API for querying and retrieving blueprints from the asset registry.

20. The non-transitory computer-readable medium of claim 19, wherein executing the blueprint comprises dynamically loading and executing the blueprint at runtime within the target application using an interpreter plugin specific to the target application's game engine.
